(19) United States
(12) Patent Application Publication
(10) Pub. No.: US 2021/0123863 A1
(43) Pub. Date: Apr. 29, 2021

(54) MONITORING DEVICES WITH SURFACE MOUNT TECHNOLOGY

(71) Applicant: Carrier Corporation, Palm Beach Gardens, FL (US)

(72) Inventors: Dennis Michael Gadonniex, Palm Beach Gardens, FL (US); Vipul Patel, Palm Beach Gardens, FL (US)

(21) Appl. No.: 17/253,546

(22) PCT Filed: May 22, 2020
(86) PCT No.: PCT/US2020/034125

§ 371 Date: Dec. 17, 2020

Related U.S. Application Data
(60) Provisional application No. 62/858,520, filed on Jun. 7, 2019.

(51) Int. Cl. G01N 21/53; G08B 17/107

(52) U.S. Cl. CPC G01N 21/53; G01N 2201/062; G08B 17/107

(57) ABSTRACT

A monitoring device includes a housing that provides a detection chamber. A plurality of radiation sources respectively emit a different type of radiation into the detection chamber. A radiation detector is situated to detect radiation emitted by the plurality of radiation sources and reflected off of airborne particles. At least one of the plurality of radiation sources and the radiation detector is surface mounted to a printed circuit board.

### CROSS-REFERENCE TO RELATED APPLICATION

This application claims priority to U.S. Provisional Application No. 62/858,520 filed Jun. 7, 2019.

### BACKGROUND

Various air quality monitoring devices are known. Smoke detectors are widely used to monitor the air in an enclosed space or building to provide a warning or alarm when smoke is present.

### SUMMARY

A monitoring device according to an example of this disclosure includes a housing that provides a detection chamber. A plurality of radiation sources respectively emit a different type of radiation into the detection chamber. A radiation detector is situated to detect radiation emitted by the plurality of radiation sources and reflected off airborne particles. At least one of the plurality of radiation sources and the radiation detector is surface mounted to a printed circuit board.

In a further example of the foregoing, the plurality of radiation sources include a first radiation source that has a first wavelength and second radiation source that has a second wavelength different from the first wavelength.

In a further example of any of the foregoing, the plurality of radiation sources include a third radiation source. The first and second radiation sources emit radiation at a first angle relative to a detection angle of the radiation detector. The third radiation source emits radiation at a second angle relative to the detection angle.

In a further example of any of the foregoing, at least one of the plurality of radiation sources and the radiation detector includes a housing that has an angled surface.

In a further example of any of the foregoing, the printed circuit board lies in a plane. The angled surface is angled relative to the plane at an angle of 1-89 degrees.

In a further example of any of the foregoing, the angle is 10-45 degrees.

In a further example of any of the foregoing, a radiation lens is received at the angled surface.

In a further example of any of the foregoing, a diode is received at the angled surface.

In a further example of any of the foregoing, an opening is provided in the printed circuit board adjacent the radiation source to allow light to emit above a first surface of the printed circuit board and below a second surface of the printed circuit board, opposite the first surface.

In a further example of any of the foregoing, the radiation source has an inclination angle of about 90 degrees.

In a further example of any of the foregoing, a reflecting component has a reflective surface that is mounted to the printed circuit board, which is adjacent the at least one of the plurality of radiation sources and the radiation detector.

In a further example of any of the foregoing, the radiation source has an inclination angle of about 0 degrees.

A monitoring device according to an example of this disclosure includes a printed circuit board provided in a plane. An optical component surface is mounted to the printed circuit board. The optical component includes a housing with an angled surface angled 1-89 degrees relative to the plane. One of a radiation lens or a photodiode is received at the angled surface.

In a further example of the foregoing, the optical component is an LED.

In a further example of any of the foregoing, the optical component is a photodiode.

In a further example of any of the foregoing, the angled surface is angled 10-45 degrees relative to the plane.

A method of manufacturing a monitoring device according to an example of this disclosure includes a surface mounting an optical component to a printed circuit board. A housing is provided over the printed circuit board to provide a detection chamber. The optical component is configured to radiate energy into, or absorb light from, the detection chamber. The monitoring device includes a plurality of radiation sources that respectively emit a different type of radiation into the detection chamber. A radiation detector is situated to detect radiation emitted by the plurality of radiation sources and reflected off airborne particles. The optical component is one of the plurality of radiation sources and the radiation detector.

These and other features may be best understood from the following specification and drawings, the following of which is a brief description.

### BRIEF DESCRIPTION OF THE DRAWINGS

FIG. 1 schematically illustrates a portion of an example monitoring device.

FIG. 2 schematically illustrates an exploded view of a portion of a second example monitoring device.

FIG. 3 schematically illustrates a portion of the monitoring device of FIG. 2.

FIG. 4 schematically illustrates a portion of the monitoring device of FIG. 3.

FIG. 5 illustrates an example radiation source.

FIG. 6 illustrates an example detector.

FIG. 7 illustrates another example monitoring device.

FIG. 8 illustrates a cross sectional view of the monitoring device of FIG. 7.

FIG. 9 illustrates a second example radiation source.

FIG. 10 illustrates another example monitoring device utilizing the example radiation source of FIG. 9.

FIG. 11 illustrates a cross sectional view of the monitoring device of FIG. 10.

FIG. 12 illustrates a third example radiation source.

FIG. 13 illustrates another example monitoring device utilizing the example radiation source of FIG. 12.

FIG. 14 illustrates a cross sectional view of the monitoring device of FIG. 13.

FIG. 15 is a flowchart diagram summarizing an example manufacturing method.

### DETAILED DESCRIPTION

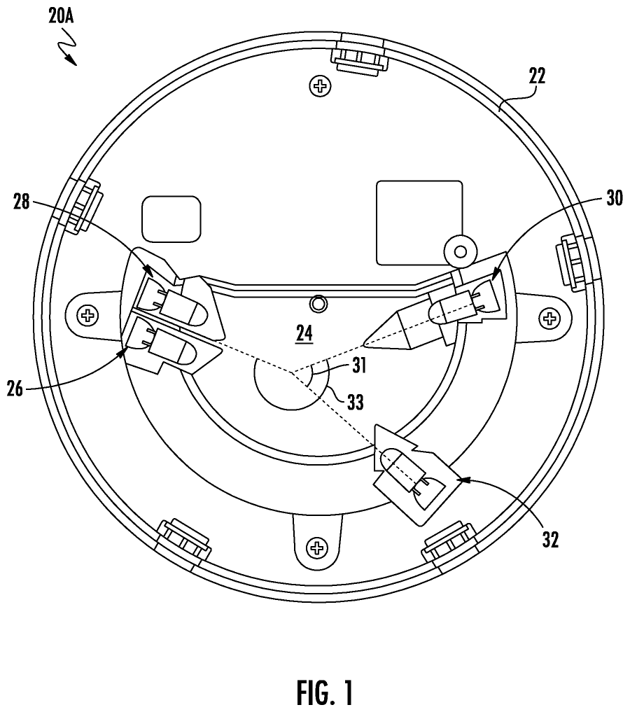

FIG. 1 schematically shows selected portions of an example monitoring device 20A. This example device 20A is configured to operate as a smoke detector and an indoor air quality monitor. The monitoring device 20A is capable of detecting various types of particles within air.

The example device 20A includes a housing assembly 22 that provides a detection chamber 24 and at least partially excludes external radiation. The portions of the housing assembly 22 that define the detection chamber 24 allow for surrounding air to enter the detection chamber 24 where particles, such as smoke particles, can be detected.

A first source of radiation 26 is situated to emit radiation into the detection chamber 24. A second source of radiation 28 emits a second, different type of radiation into the detection chamber 24. In an example, the radiation from the sources 26 and 28 comprises light having different wavelengths. For example, the first source of radiation 26 emits blue light and the second source of radiation 28 emits red light. Other forms of light having different wavelengths may be used in other examples for detecting particular types of airborne particles. Some examples include ultraviolet light, which allows for detecting fluorescence of some particles. Other examples include infrared light.

The monitoring device 20A includes at least one detector 30 that is situated to detect radiation reflected from particles in the detection chamber 24. In some examples, the detector 30 is a photodiode. In some examples, multiple detectors may be utilized.

In some examples, as shown, a third source of radiation 32 is situated to emit radiation into the detection chamber 24. In some examples, as shown, the third source of radiation 32 emits light at a backscatter angle 31 relative to the detector 30, which is different than the forward scatter angle 33 of the first and second sources 26, 28 relative to the detector 30.

Although FIG. 1 illustrates an example device 20A having a three radiation source and one detector configuration, other configurations, including two radiation sources and two detectors, such as in the example device 20B discussed below, may also benefit from this disclosure.

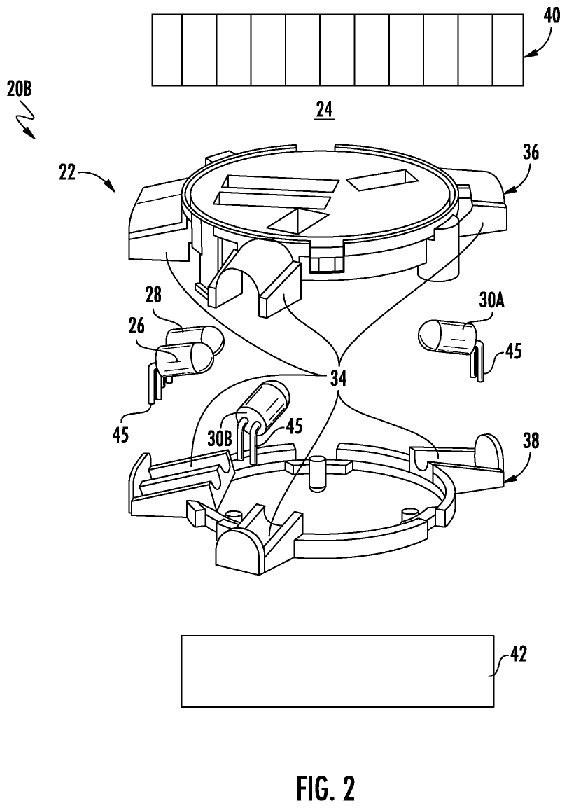

FIG. 2 schematically illustrates an exploded view of portions 36, 38, 40 of the housing assembly 22 and the optical components—the radiation sources 26, 28 and the detectors 30A, 30B of a second example monitoring device 20B. The example device 20B includes two radiation sources 26, 28 and two detectors 30A, 30B. The optic cover portion 36 and optic mount portion 38 of the housing assembly 22 include supporting features 34 for supporting the radiation sources 26, 28, and the detectors 30A, 30B. In some examples, the supporting features 34 provide the optical angular relationships between the radiation sources 26, 28 and the detectors 30A, 30B. As shown schematically, a labyrinth portion 40 and the optic portion 36 of the housing assembly 22 at least partially bound the detection chamber 24. The radiation sources 26, 28 and the detectors 30A, 30B include wiring 45 that extends through openings in the optic mount portion 38 of the housing assembly 22 to electrically connect with a printed circuit board (PCB) 42.

In each of the FIGS. 1 and 2 examples, specific angular relationships between the optical components may be provided.

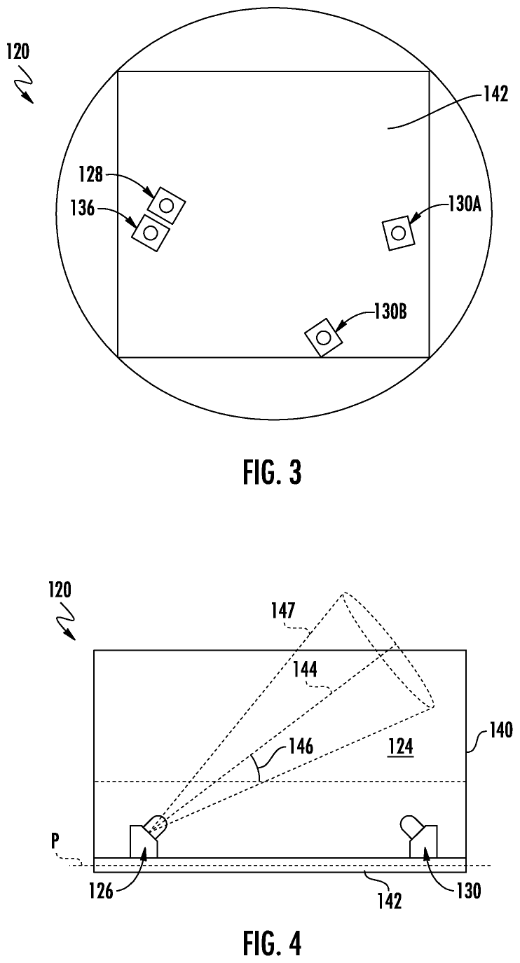

FIG. 3 schematically illustrates a portion of an example monitoring device 120. It should be understood that like reference numerals identify corresponding or similar elements throughout the several drawings. The example device 120 is substantially similar to the device 20B, except that the radiation sources 126, 128 and the detectors 130A, 130B are mounted to the PCB 142 using surface mount technology. That is, the radiation sources 126, 128 and the detectors 130A, 130B are placed directly on the PCB 142.

While the illustrative example shows all radiation sources 126, 128 and the detectors 130A, 130B being surface mounted to the PCB 142, in other examples, any number of radiation sources and detectors may be surface mounted to the PCB 142. The positional relationships between the radiation sources 126, 128 and the detectors 130A, 130B are exemplary, and other configurations, including those with more or fewer radiation sources or detectors, and including the configuration shown in FIG. 1 having three sources and one detector, may be utilized in some examples.

FIG. 4 schematically illustrates a portion of the example device 120 of FIG. 3. A labyrinth 140 is placed over at least a portion of the PCB 142, directly or indirectly, to provide a detection chamber 124. In FIG. 4, only the radiation source 126 and a single detector 130 are shown for ease of viewing. The radiation source 126 is positioned such that its central viewing cone axis 144 forms an inclination angle 146 with the plane P of the PCB 142. The central viewing cone axis 144 is defined as the central axis to the emission cone 147 of the example radiation source 126. In some examples, the inclination angle 146 is 1-89 degrees. In some examples, the inclination angle is between 10-45 degrees. The inclination angle 146 determines the amount of smoke intersected by the emission cone 147 of the radiation source 126.

In some examples, the radiation sources 126, 128 and the detectors 130A, 130B are surface mounted to the PCB 142 before the housing is placed over the PCB 142. In some examples, an optic mount, such as optic mount 38 shown in the FIG. 2 example, is not utilized. In some examples, the device 120 does not utilize housing components with openings for allowing wiring to run from the radiation sources 126, 128 and the detectors 130A, 130B which are surface mounted to the PCB 142.

FIG. 5 illustrates the example radiation source 126 of FIGS. 3 and 4. The radiation source 126 is surface mounted to the PCB 142. In the illustrative example, the radiation source 126 includes a radiation lens portion 148 mounted on a housing 150. The housing 150 provides the electrical connection with the PCB 142. In some examples, the lens portion 148 may be a light emitting diode (LED) having any lens shape. As shown, the example housing 150 provides an angled surface 152 that is angled at an angle 154 with the plane P of the PCB 142. The lens portion 148 is received at the angled surface 152. The angle 154 may be customized to provide a precise inclination angle 146 of the central viewing cone axis 144. In some examples, the angle 154 is 1-89 degrees. In some examples, the angle 154 is between 10-45 degrees. In some examples, the housing 150 is mounted to the PCB 142 using solder paste.

The housing 150 may include a surface 155 that is substantially parallel to the plane P when the housing 150 is received on the PCB 142. The surface 155 may provide a reference plane for customizing the angle of the angles surface 152, such that angular relationship between the surfaces 152, 155 is the same as the desired angle 154.

Although the illustrative example refers to the radiation source 126, other optical components, including any number of the radiation source 128 and the detectors 130A, 130B of FIGS. 3 and 4 in some examples, may have a similar configuration.

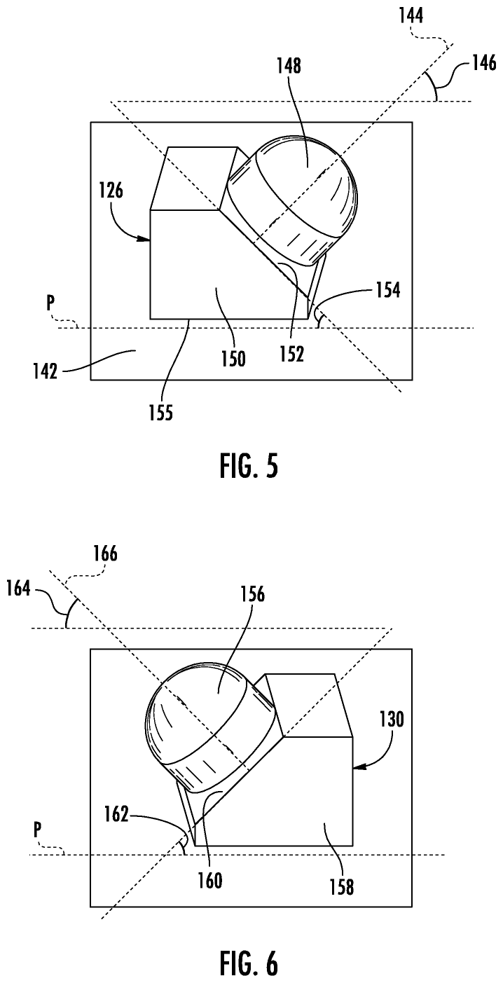

FIG. 6 illustrates an example detector 130 having a similar configuration to the example radiation source 126 of FIG. 5. A photodiode lens 156 may be mounted on mounted on the diode housing 158, which includes an angled surface 160 for receiving the photodiode. The angled surface 160 provides an angle 162 with the plane P for customizing an angle 164 of a viewing axis 166 of the photodiode 156. In some examples, the angle 164 is 1-89 degrees. In some examples the angle 164 is 10-45 degrees.

FIG. 7 illustrates an exploded view of an example monitoring device 220 substantially similar to the example device 120 of FIGS. 3-6. The device 220 is configured to have two radiation sources 226, 228 and two detectors 230A, 230B. In other examples, a configuration like that in FIG. 1 having three radiation sources and one detector may be utilized. In some examples, as shown, the radiation sources 226, 228 and detectors 230A, 230B are configured like radiation source 126 and detector 130 of FIGS. 4-6. The radiation sources 226, 228 and detectors 230A, 230B are surface mounted to the PCB 242. The optic cover 236 is placed onto the PCB 242 and includes openings 243 for the radiation sources 226, 228 and detectors 230A, 230B to extend through. A labyrinth 240 is provided over the optic cover 236.

The optic cover 236 and labyrinth 240 can include nylon polypropylene or polystyrene and can be composed of an electrically conductive material, light absorbing material, or flame retardant material. In some examples, the optic cover 236 does not include structure for providing the desired angles of the optical components, as that is provided by the surface mounted optical components. In some examples, the optics cover 236 may be contoured to shield the detectors 230A, 230B from stray radiation outside the desired forward scatter and back scatter angles (such as, for example, from reflections against the sides of the labyrinth 240 of radiation from the radiation sources 226, 228).

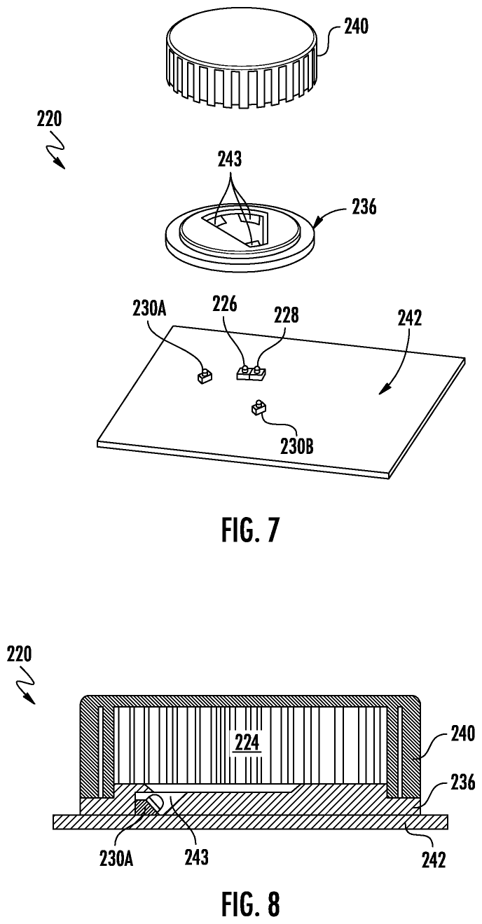

FIG. 8 illustrates a cross sectional view of the monitoring device 220. The labyrinth 240 and optics cover 236 provide a detection chamber 224 there between, into which the radiation sources 226, 228 and detectors 230A, 230B mounted to the PCB 242 are aimed through the openings 243 (see also FIG. 7).

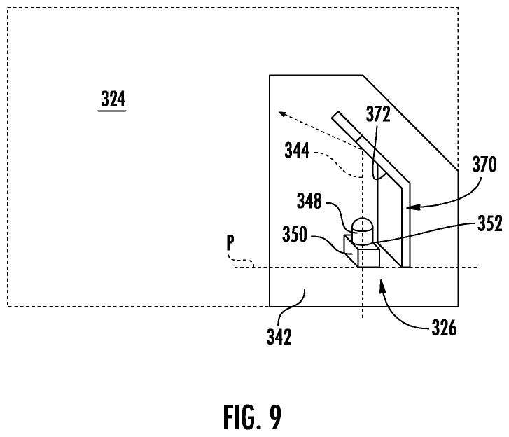

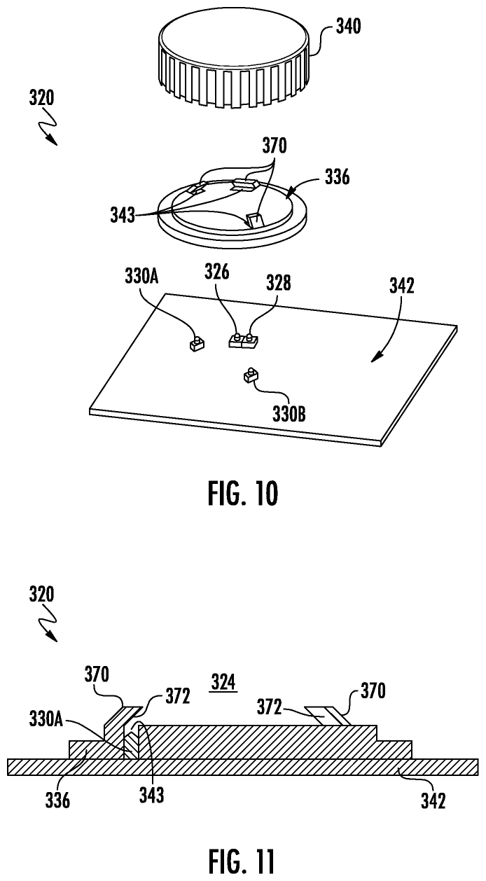

FIG. 9 illustrates another example radiation source 326 which may be used in an example monitoring device such as for example the device described below with reference to FIG. 10. The example radiation source 326 is surface mounted to the PCB 342. A radiation device 348 is mounted on a base 350. The example upper surface 352 is substantially parallel with the plane P of the PCB 342 such that the central viewing cone axis 344 is substantially perpendicular to the plane P. A reflecting component 370 is located adjacent the radiation device 348 and includes a reflective surface 372 for reflecting energy from the radiation device at a desired angle into a detection chamber 324 (shown schematically). Although FIG. 9 illustrates an example radiation source 326, in some examples, detectors may also benefit from a similar configuration whereby a reflecting component reflects energy at an angle from the detection chamber 324 to a detector.

FIG. 10 illustrates an example monitoring device 320 utilizing the example radiation source 326 of FIG. 9 and similarly mounted radiation source 328 and detectors 330A, 330B. An optic cover 336 is placed onto the PCB 342 and includes openings 343 for the energy of radiation sources 326, 328 and detectors 330A, 330B to extend through (see also FIG. 11). A labyrinth 340 is provided over the optic cover 336. As shown, the reflecting components 370 may be extensions of the optic cover 336 in some examples. As shown, the reflecting components 370 may be provided adjacent the openings 343 in some examples.

FIG. 11 illustrates a cross sectional view of a portion of the monitoring device 320 of FIG. 10. The example reflective surface 372 is provided on the reflecting component 370 of the optic cover 336. The reflecting surfaces 370 may be used in any number of detectors 330A (as shown), 330B and radiation sources 326, 328 (see FIGS. 9-10). The reflecting surfaces 372 for the radiation sources create the vertical angles to illuminate the smoke sensing volume. The reflecting surfaces 372 for the detectors 330A, 330B collect signal from the smoke volume at the desired vertical angle.

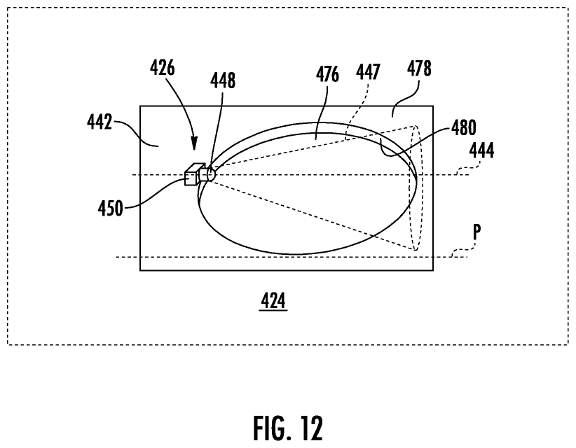

FIG. 12 illustrates another example radiation source 426. The example radiation source 426 is surface mounted to the PCB 442. A radiation device 448 is mounted to a base 450 and the base 450 is positioned on the PCB 442, such that the central viewing cone axis 444 is substantially parallel to the plane P of the PCB 442.

An opening 476 is provided on the PCB 442 adjacent the radiation source 426, such that emitted light, such as that of emission cone 447 extends above an upper surface 478 of the PCB and below a lower surface 480 of the PCB opposite the upper surface. The words “upper,” “lower,” “above,” and “below” are used here with regard to the orientation shown in the Figure, but may not necessarily demonstrate the orientation of the device when operating. The opening 476 also prevents light from reflecting off of the upper surface 478 in some examples. As shown schematically, a detection chamber 424 may be provided above the upper surface 478 and below the lower surface 480 in some examples. In some examples, the opening 476 is 1-2.5 inches (2.5-6.4 cm) in diameter. Various shapes for the opening 476 are contemplated.

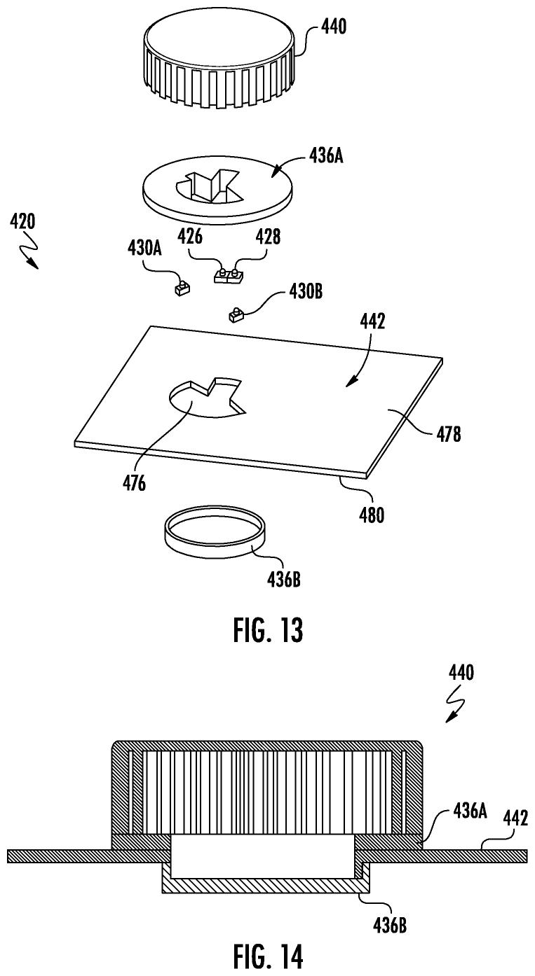

FIGS. 13 and 14 illustrate an example monitoring device 420 utilizing the radiation source 426 and similarly mounted radiation source 428 and detectors 430A, 430B. An optic cover 436A is placed onto the surface 478 of the PCB 442, and a second optic cover 436B is placed on the lower surface 480. A labyrinth 440 is provided over the optic cover 436A. The opening 476 is provided in the PCB 442 adjacent the radiation sources 426, 428, and detectors 430A, 430B. The opening 476 may be contoured to shield the detector 430A, 430B from stray radiation outside of the desired forward and back scatter angles from the radiation sources 426, 428. FIG. 14 illustrates a cross sectional view of the monitoring device 420.

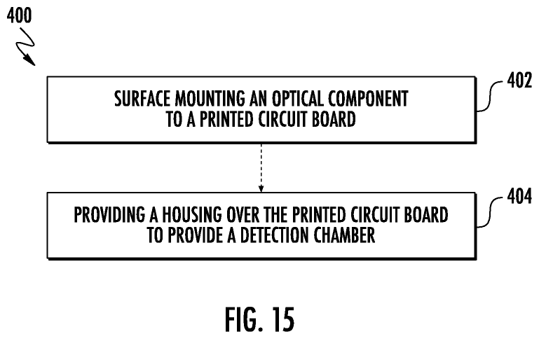

FIG. 15 illustrates a flow chart of an example method 400 of assembling a monitoring device 120/220/320/420, which can be utilized with any of the monitoring device examples, or combinations thereof, disclosed in FIGS. 1-14. At 402, the method 400 includes surface mounting an optical component to a printed circuit board. At 404, the method 400 includes providing a housing over the printed circuit board to provide a detection chamber, such that the optical component radiates energy into, or absorbs energy from, the detection chamber.

In some disclosed examples, cost and ease of assembly is improved. In some disclosed examples, precision of angular relationships among the components may be achieved. In some disclosed examples, more compact detection chambers may be utilized. In some disclosed examples, manufacturing complexity is reduced.

Although the different examples are illustrated as having specific components, the examples of this disclosure are not limited to those particular combinations. It is possible to use some of the components or features from any of the embodiments in combination with features or components from any of the other embodiments.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A monitoring device, comprising:
a housing providing a detection chamber;
a plurality of radiation sources that respectively emit a different type of radiation into the detection chamber;
a radiation detector situated to detect radiation emitted by the plurality of radiation sources and reflected off airborne particles; and
a printed circuit board, wherein at least one of the plurality of radiation sources and the radiation detector is surface mounted to the printed circuit board.

2. The monitoring device as recited in claim 1, wherein the plurality of radiation sources includes a first radiation source having a first wavelength and a second radiation source having a second wavelength different from the first wavelength.

3. The monitoring device as recited in claim 2, wherein the plurality of radiation sources includes a third radiation source, the first and second radiation sources emit radiation at a first angle relative to a detection angle of the radiation detector, and the third radiation source emits radiation at a second angle relative to the detection angle.

4. The monitoring device as recited in claim 1, wherein the at least one of the plurality of radiation sources and the radiation detector includes a housing having an angled surface.

5. The monitoring device as recited in claim 4, wherein the printed circuit board lies in a plane, and the angled surface is angled relative to the plane at an angle of 1-89 degrees.

6. The monitoring device as recited in claim 5, wherein the angle is 10-45 degrees.

7. The monitoring device as recited in claim 5, wherein a radiation lens is received at the angled surface.

8. The monitoring device as recited in claim 5, wherein a diode is received at the angled surface.

9. The monitoring device as recited in claim 1, wherein the at least one of the plurality of radiation sources and the radiation detector is a radiation source, and an opening is provided in the printed circuit board adjacent the radiation source to allow light to emit above a first surface of the printed circuit board and below a second surface of the printed circuit board opposite the first surface.

10. The monitoring device as recited in claim 7, wherein the radiation source has an inclination angle of about 90 degrees.

11. The monitoring device as recited in claim 1, wherein a reflecting component having a reflective surface is mounted to the printed circuit board adjacent the at least one of the plurality of radiation sources and the radiation detector.

12. The monitoring device as recited in claim 9, wherein the radiation source has an inclination angle of about 0 degrees.

13. A monitoring device, comprising:
a printed circuit board provided in a plane; and
an optical component surface mounted to the printed circuit board, the optical component comprising a housing with an angled surface angled 1-89 degrees relative to the plane, and one of a radiation lens or a photodiode received at the angled surface.

14. The monitoring device as recited in claim 13, wherein the optical component is an LED.

15. The monitoring device as recited in claim 13, wherein the optical component is a photodiode.

16. The monitoring device as recited in claim 13, wherein the angled surface is angled 10-45 degrees relative to the plane.

17. A method of manufacturing a monitoring device, the method comprising:
surface mounting an optical component to a printed circuit board; and
providing a housing over the printed circuit board to provide a detection chamber, wherein the optical component is configured to radiate energy into, or absorb light from, the detection chamber, the monitoring device comprises a plurality of radiation sources that respectively emit a different type of radiation into the detection chamber and a radiation detector situated to detect radiation emitted by the plurality of radiation sources and reflected off airborne particles, and the optical component is one of the plurality of radiation sources and the radiation detector.
